(19) United States
(12) Patent Application Publication
(10) Pub. No.: US 2011/0253920 A1
(43) Pub. Date: Oct. 20, 2011

(54) Vacuum means for storage bags

(75) Inventor: Man Chiu LI, Kwun Tong (HK)

(73) Assignee: Potter Industries Limited, Kwun Tong (HK)

(21) Appl. No.: 12/763,229

(22) Filed: Apr. 20, 2010

(51) Int. Cl. F16L 37/28; F16K 51/00

(52) U.S. Cl. 251/149.1

(57) ABSTRACT

The present invention relates to a vacuum means for storage bags which comprises an air exhaustion opening and an air exhaustion valve, both of which are disposed on an outer surface of the storage bag; the air exhaustion opening and the air exhaustion valve are interconnected; the air exhaustion valve comprises two or more layers of soft sealing plates, and the layers of soft sealing plates overlap with one another and their edges are connected with the storage bag in a sealed manner; ventilation openings separated from one another are opened on each of the two or more layers of soft sealing plates, and each of the two or more layers of soft sealing plates are interconnected with the air exhaustion opening at areas where the ventilating openings are opened. The air exhaustion valve of the present invention mainly attains sealing effect by adhering the soft sealing plates with one another. As the soft sealing plates are softer and more resilient, it is easier for them to resume their original shapes. It is also easier for them to adhere to one another without leaving any space in between. Therefore, in comparison with existing vacuum means which attains vacuum by adhering hard material to soft material, the present invention has a better sealing effect and maintains vacuum for a longer period of time. Besides, as the costs of raw materials are lower and the manufacturing process is simpler, the costs of the present invention are lower and so the present invention has more significant economic benefits. The present invention is widely applicable to various forms of existing storage bags and so has a higher adaptability. Besides, in comparison with existing vacuum means which attains vacuum by applying adhesives to adhere the soft sealing plates to one another, the present invention attains sealing effect without the need of any adhesives. Therefore, the sealing effect would not be affected due to weakening of adhesive power of the adhesives, and the soft sealing plates would not be unable to separate from one another as they are adhered to each other for a long time.

### BACKGROUND OF THE INVENTION

The present invention relates to vacuum storage bags and more particularly pertains to a vacuum means for vacuum storage bags.

In domestic life, it is getting more and more common to use vacuum storage bags for houseware storage. Such storage method has the advantages of low costs, simple operation and convenient use. It is also effective in resisting moisture, mold and bugs. Existing vacuum storage bags share similar structures, which comprise an air tight hollow bag body disposed with a sealable bag opening on one side thereof and an air exhaustion valve thereon. FIG. 1 illustrates a common air exhaustion valve which comprises a lower member 3, an upper member 4, a silicon sealing plate 5 and a pressed cover 6. The silicon sealing plate 5 is disposed in between the lower member 3 and the upper member 4. The pressed cover 6 is connected with the upper member 4 and presses against the silicon sealing plate 5 via the upper member 4 in a sealed manner. Corresponding ventilating openings are disposed at the lower portion of the lower member 3 and on the upper member 4. This type of air exhaustion valve maintains vacuum merely by adhering the single piece of silicon sealing plate to the upper surface of the lower member. Even with the pressing force exerted by the pressed cover, if the upper surface of the lower member or the surface of the silicon sealing plate is not smooth enough, gaps unavoidably exist in between the silicon sealing plate and the upper surface of the lower member. As a result, air would leak into the bag so that vacuum degree in the bag decreases and storage effect is affected. In practice, the lower member is usually made of hard plastics with a low degree of resilience, therefore making it more difficult to completely adhere to the soft silicon sealing plate to attain high degree of sealing. Therefore, existing products could not fulfill the needs for long-lasting air-tight storage.

### BRIEF SUMMARY OF THE INVENTION

In view of the aforesaid disadvantages now present in the prior art, the present invention provides a vacuum means for storage bags which is simple and reasonable in structure and low in costs. It has a better sealing effect and maintains vacuum for a longer period of time.

To attain this, the present invention generally comprises an air exhaustion opening and an air exhaustion valve, both of which are disposed on an outer surface of the storage bag; the air exhaustion opening and the air exhaustion valve are interconnected; the air exhaustion valve comprises two or more layers of soft sealing plates, and the layers of soft sealing plates overlap with one another and their edges are connected with the storage bag in a sealed manner; ventilation openings separated from one another are opened on each of the two or more layers of soft sealing plates, and each of the two or more layers of soft sealing plates are interconnected with the air exhaustion opening at areas where the ventilating openings are opened.

To position a vacuum device such as a vacuum cleaner nozzle on an operating area of the exhaustion valve, the present invention further comprises an air exhaustion flange. The air exhaustion flange is disposed with an opening which is interconnected with the air exhaustion opening. During operation the vacuum device such as a vacuum cleaner nozzle is inserted into the air exhaustion flange so that it is fixed in place for operation.

The ventilation openings may be opened on an edge or at a center of each of the two or more layers of soft sealing plates provided that the ventilation openings of each of the layers are separated from one another and interconnected with the air exhaustion opening.

There is no restriction on the number of ventilation openings on the soft sealing plates. It is possible to have one or more ventilation openings. If there are more ventilation openings, the air suction speed is faster; but as the distance between the ventilation openings is also smaller, air leakage is easier. In contrast, if there are less ventilation openings, the distance therebetween is larger, and air suction speed is slower, but vacuum could be maintained for a longer period of time. In practice, each of the layers of soft sealing plate preferably has 2-8 ventilation openings. Distance between ventilation openings of adjacent layers of soft sealing plates is greater than or equal to 3 mm. However, if the ventilation openings are arranged in good order, even if there is only one ventilation opening in the soft sealing plate, it is possible to attain sealing effect. The ventilation openings may be in shape of circle, ellipse, triangle, square, polygon or irregular shapes, preferably in shape of circle.

The layers of soft sealing plates are preferably disposed in parallel to each other. The soft sealing plate has a flat and smooth surface for better sealing effect.

Apart from the soft sealing plates, the air exhaustion valve further comprises a layer of filtering mesh. The layer of filtering mesh is disposed at the air exhaustion valve at an outermost layer of the storage bag and so it is directly in contact with objects inside the storage bag. The filtering mesh guarantees that smaller objects inside the storage bag will not be sucked away and that air exhaustion remains unaffected by preventing direct contact between objects with smoother surfaces inside the storage bag and the soft sealing plates.

The soft sealing plates are made of plastics with smooth surfaces, preferably polyvinyl chloride (PVC) but other materials such as polypropylene (PP), polyethylene (PE), polyethylene terephthalate (PET), nylon, chlorinated polyethylene (CPE), polyurethane (PU) and thermoplastic polyurethane (TPU) and so forth are also acceptable.

The operating principle of the present vacuum means for storage bag is set out as follows: When a user aligns a vacuum cleaner nozzle with the air exhaustion opening on the outer surface of the storage bag to exhaust air from the storage bag, air will be extracted out of the bag via the ventilation openings disposed on the soft sealing plates until the air inside the bag is completely exhausted. Air pressure outside the bag is then higher than air pressure inside the bag. Due to this difference in air pressure, the layers of soft sealing plates will be pressed against one another without leaving any space in between, and so ventilation openings on the each of the layers of soft sealing plates will then be sealed by adjacent soft sealing plates. Air leakage from outside to inside of the bag can therefore be effectively prevented and the vacuum state inside the bag can be better maintained.

In comparison with the prior art, the present invention has the following advantages: The air exhaustion valve of the present invention mainly attains sealing effect by adhering the soft sealing plates with one another. As the soft sealing plates are softer and more resilient, it is easier for them to resume their original shapes. It is also easier for them to adhere to one another without leaving any space in between. Therefore, in comparison with existing vacuum means which attains vacuum by adhering hard material to soft material, the present invention has a better sealing effect and maintains vacuum for a longer period of time. Besides, as the costs of raw materials are lower and the manufacturing process is simpler, the costs of the present invention are lower and so the present invention has more significant economic benefits. The present invention is widely applicable to various forms of existing storage bags and so has a higher adaptability. Besides, in comparison with existing vacuum means which attains vacuum by applying adhesives to adhere the soft sealing plates to one another, the present invention attains sealing effect without the need of any adhesives. Therefore, the sealing effect would not be affected due to weakening of adhesive power of the adhesives, and the soft sealing plates would not be unable to separate from one another as they are adhered to each other for a long time.

### BRIEF DESCRIPTION OF THE DRAWINGS

FIG. 1 illustrates an existing vacuum means for storage bags.

FIG. 2 illustrates the structure of the vacuum means of storage bags of the present invention.

FIG. 3 is an exploded view of the vacuum means of storage bags of the present invention as shown in FIG. 2.

FIG. 4 illustrates the outermost layer of soft sealing plate of the air exhaustion valve of the vacuum means of storage bags of the present invention as shown in FIG. 2.

FIG. 5 illustrates the middle layer of soft sealing plate of the air exhaustion valve of the vacuum means of storage bags of the present invention as shown in FIG. 2.

FIG. 6 illustrates the innermost layer of soft sealing plate of the air exhaustion valve of the vacuum means of storage bags of the present invention as shown in FIG. 2.

FIG. 7 illustrates the layers of soft sealing plates of the air exhaustion valve of the vacuum means of storage bags of the present invention as shown in FIG. 2 overlapping with one another.

FIG. 8 illustrates the position of the ventilation openings of the soft sealing plate in another embodiment.

FIG. 9 illustrates the position of the ventilation openings of the soft sealing plate in another embodiment.

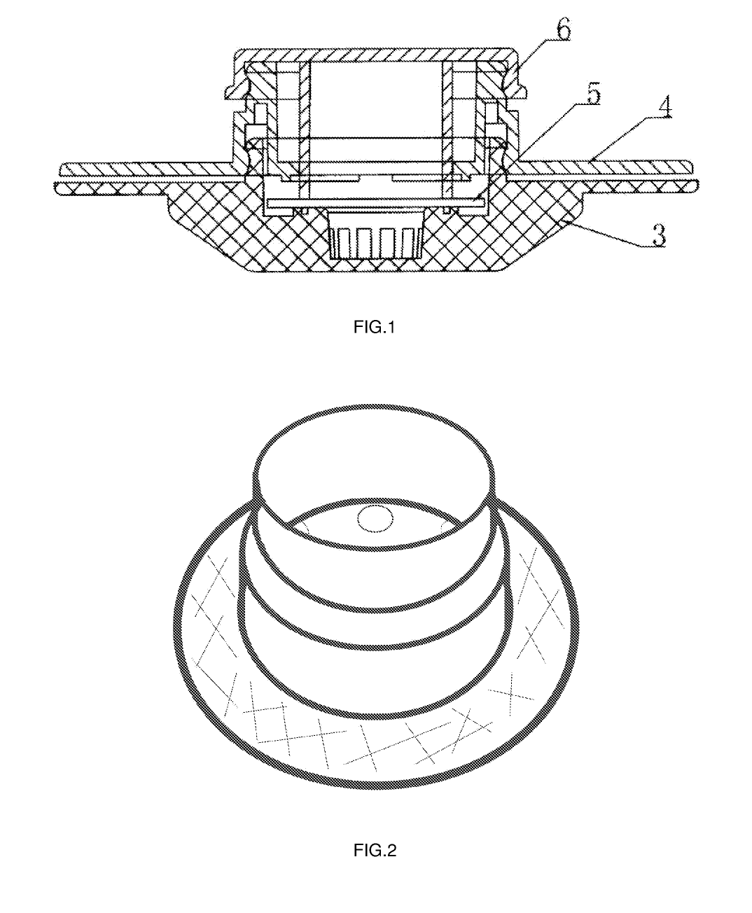

### DETAILED DESCRIPTION OF THE INVENTION

The present invention is described in further details below with reference to preferred embodiments and accompanying drawings, but the present invention is not limited by the embodiments below.

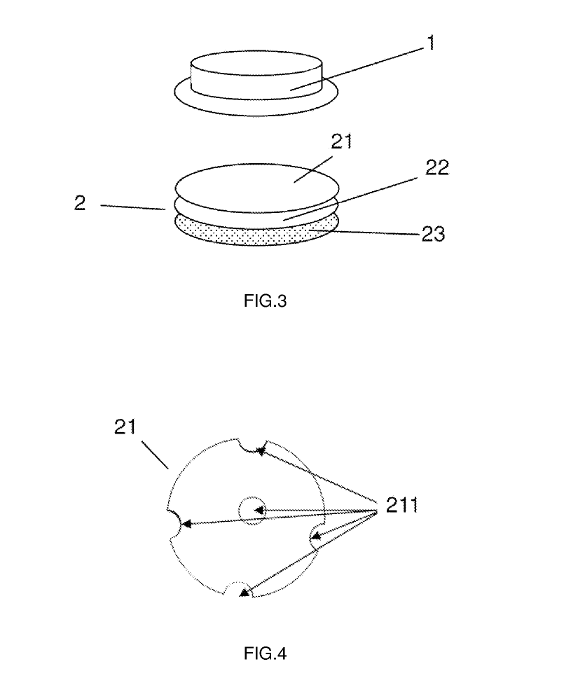

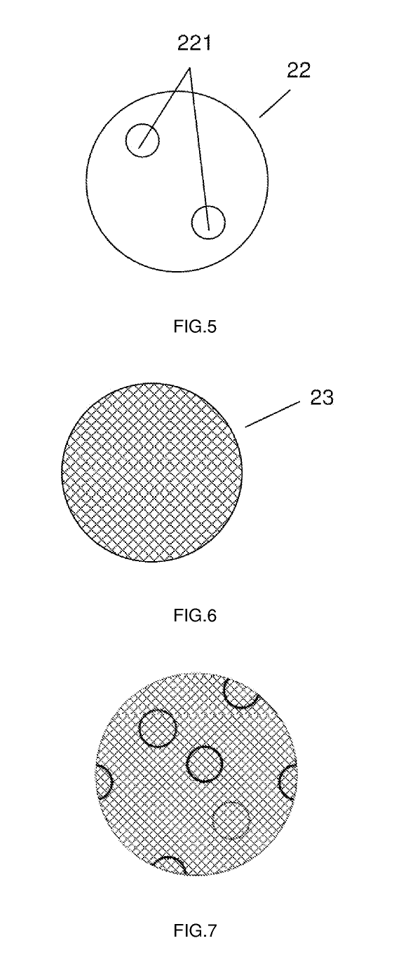

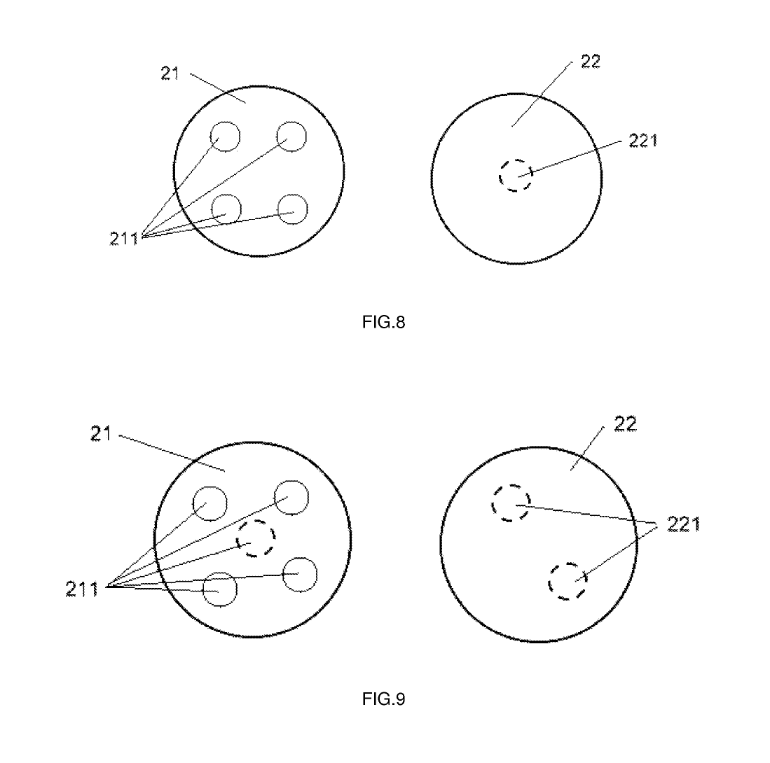

Detailed structure of the present invention is illustrated in FIG. 2 to FIG. 7. As illustrated in FIG. 2, the present vacuum means for storage bag is disposed at one side of the storage bag. The storage bag is disposed with a sealable opening. The present vacuum means for storage bag comprises an air exhaustion opening (not illustrated in the figures), an air exhaustion flange 1 and an air exhaustion valve 2, all of which are disposed on an outer surface of the storage bag. The function of the air exhaustion flange 1 is to position a vacuum device such as a vacuum cleaner nozzle on an operating area of the exhaustion valve. The air exhaustion flange 1 is disposed with an opening which is interconnected with the air exhaustion opening. In other embodiments, the air exhaustion flange 1 may be removed in order to save costs. The air exhaustion opening and the air exhaustion valve 2 are interconnected and their structures are illustrated in FIG. 3. The air exhaustion valve 2 comprises three layers of materials, namely two layers of soft sealing plates 21, 22 and one layer of filtering mesh 23. The three layers of materials overlap with one another in a parallel orientation and their edges are connected with the storage bag in a sealed manner. The shapes of the two layers of soft sealing plates 21, 22 and the layer of filtering mesh 23 are illustrated in FIG. 4 to FIG. 7. Ventilating openings 211, 221 separated from one another are opened on the two layers of soft sealing plates 21, 22. The two layers of soft sealing plates are interconnected with the air exhaustion opening at areas where the ventilating openings are opened. The layer of soft sealing plate 21 disposed at an outermost side of the storage bag has some of its ventilation openings in shape of semi-circle disposed at its edge, and a ventilation opening in shape of circle disposed at its center. The layer of soft sealing plate 22 in middle has two ventilation openings 221 in shape of circle. The two ventilation openings 221 are disposed in an area between centre and edge of the soft sealing plate and are separated from the ventilation openings in shape of circle opened on the outermost layer of soft sealing plate 21 at a distance. In other embodiments, the ventilation openings on the two layers of soft sealing plates can be opened at different positions provided that the ventilation openings of each of the layers are separated from one another and interconnected with the air exhaustion opening. Possible positions of the ventilation openings on the two layers of soft sealing plates in other embodiments are illustrated in FIGS. 8 and 9. The two layers of soft sealing plates 21, 22 each has a surface which is flat and smooth in order to achieve better sealing effect. The filtering mesh 23 is disposed at the air exhaustion valve at an outermost layer of the storage bag and so it is directly in contact with objects inside the storage bag. The filtering mesh 23 guarantees that smaller objects inside the storage bag will not be sucked away and that air exhaustion remains unaffected by preventing direct contact between objects with smoother surfaces inside the storage bag and the soft sealing plates. The soft sealing plates 21, 22 are made of plastics with smooth surfaces, preferably polyvinyl chloride (PVC) but other materials such as polypropylene (PP), polyethylene (PE), polyethylene terephthalate (PET), nylon, chlorinated polyethylene (CPE), polyurethane (PU) and thermoplastic polyurethane (TPU) and so forth are also acceptable.

The operating principle of the present vacuum means for storage bag is set out as follows: When a user aligns a vacuum cleaner nozzle with the air exhaustion opening on the outer surface of the storage bag to exhaust air from the storage bag, air will be extracted out of the bag via the ventilation openings 211, 221 disposed on the soft sealing plates 21, 22 until the air inside the bag is completely exhausted. Air pressure outside the bag is then higher than air pressure inside the bag. Due to this difference in air pressure, the layers of soft sealing plates 21, 22 will be pressed against one another without leaving any space in between, and so ventilation openings 211, 221 on the each of the layers of soft sealing plates will then be sealed by adjacent soft sealing plates 21, 22 (as illustrated in FIG. 7). Air leakage from outside to inside of the bag can therefore be effectively prevented and the vacuum state inside the bag can be better maintained.

The above embodiment is a preferred embodiment of the present invention. The present invention is capable of other embodiments and is not limited by the above embodiment. Any other variation, decoration, substitution, combination or simplification, whether in substance or in principle, not deviated from the spirit of the present invention, is replacement or substitution of equivalent effect and falls within the scope of protection of the present invention.

What is claimed is:

1. A vacuum means for storage bag which comprises an air exhaustion opening and an air exhaustion valve, both of which are disposed on an outer surface of the storage bag; the air exhaustion opening and the air exhaustion valve are interconnected; characterized in that the air exhaustion valve comprises two or more layers of soft sealing plates, and the layers of soft sealing plates overlap with one another and their edges are connected with the storage bag in a sealed manner; ventilation openings separated from one another are opened on each of the two or more layers of soft sealing plates, and each of the two or more layers of soft sealing plates are interconnected with the air exhaustion opening at areas where the ventilating openings are opened.

2. The vacuum means for storage bag as in claim 1, characterized in that the ventilation openings may be opened on an edge or at a center of the two or more layers of soft sealing plates, and the ventilation openings of each of the layers are separated from one another.

3. The vacuum means for storage bag as in claim 1, characterized in that it further comprises an air exhaustion flange, and the air exhaustion flange is disposed with an opening which is interconnected with the air exhaustion opening.

4. The vacuum means for storage bag as in claim 1, characterized in that each layer of soft sealing plate preferably has 2-8 ventilation openings.

5. The vacuum means for storage bag as in claim 1, characterized in that distance between ventilation openings of adjacent layers of soft sealing plates is greater than or equal to 3 mm.

6. The vacuum means for storage bag as in claim 1, characterized in that the ventilation openings are in shape of circle, ellipse, triangle, square or polygon.

7. The vacuum means for storage bag as in claim 1, characterized in that the layers of soft sealing plates are disposed in parallel to one another; and the soft sealing plate has a flat and smooth surface.

8. The vacuum means for storage bag as in claim 1, characterized in that it further comprises a layer of filtering mesh which is disposed at the air exhaustion valve at an outermost layer of the storage bag.

9. The vacuum means for storage bag as in claim 1, characterized in that the soft sealing plates are made of plastics with smooth surfaces.

10. The vacuum means for storage bag as in claim 9, characterized in that the plastics with smooth surfaces are preferably polyvinyl chloride (PVC), or other materials including polypropylene (PP), polyethylene (PE), polyethylene terephthalate (PET), nylon, chlorinated polyethylene (CPE), polyurethane (PU) and thermoplastic polyurethane (TPU).
